(19) United States
(12) Patent Application Publication
(10) Pub. No.: US 2004/0036447 A1
(43) Pub. Date: Feb. 26, 2004

(54) Portable power source for portable computers and communication device

(75) Inventors: Michael Leviel, Petah Tiqua (IL); Azir Trachtenberg, Kfar Saba (IL); Joseh Schori, Yehud (IL); Gal Peari, Rosh Haayin (IL)

Correspondence Address: DENNISON, SCHULTZ & DOUGHERTY, Suite 612, 1745 Jefferson Davis Highway, Arlington, VA, 22202, US

(73) Assignee: Tadiran Communications, Ltd., Holon (IL)

(21) Appl. No.: 10/225,238

(22) Filed: Aug. 22, 2002

(51) Int. Cl. H02J 7/00

(52) U.S. Cl. 320/117

(57) ABSTRACT

A portable power supply for powering a handheld data-processing and telecommunication device, comprising a conventional battery situated internally to the device, and an external, easily detached and exchangeable battery pack, whereby the external, easily detached and exchangeable battery pack powers the device, and the internal, conventional battery acts as a backup power supply.

### FIELD OF THE INVENTION

The present invention is directed to a portable power supply for handheld data-processing and telecommunication devices.

### BACKGROUND OF THE INVENTION

There is a general trend towards miniaturization and portability of telecommunication devices and personal data-processing equipment. A major breakthrough in this field is the so-called palmtop computer. Although the features of these devices vary between manufacturers and from model to model, they are generally characterized by having a database for the storing of telephone numbers and the like, the ability to process data, to send and receive electronic mail, an internal diary, a programmable alarm and often, the ability to connect to the Internet. At the time of writing, companies producing on such devices include Palm, Sony, Psion, Apple, 3Com, Compaq, HP and Hellio.

One of the drawbacks of the Palmtop computer is that the requirement of portability necessitates an internal power supply, typically a rechargeable battery, but the sizeable power consumption of the display screen, the remote transmission/reception of electronic data, the powerful central processor, PCMCIA cards and other add-ons, heavy software applications running thereon, and cooling systems associated therewith, limit the operational lifetimes of these devices between recharging. Recharging is usually achieved by connecting the palmtop computer to a mains power supply via a rectifier and transformer block, and trickle charging. It is a time consuming process, and whilst being performed, effectively requires the palmtop computer to be anchored to a mains power supply, or at least to an automobile or the like, significantly reducing its mobility.

Although recent improvements to the reliability and capacity of rechargeable batteries enable such devices to perform well, throughout the typical business day, nevertheless, the requirement for recharging of the internal power supply severely adversely affects their true portability. When used around the clock, particularly where recharging facilities are not available, palmtop computers run out of power and become useless until recharged. Although it is technically possible to carry spare power packs and to open up the computer, disconnect the internal power supply and replace with a fully charged one, the battery compartments of palmtop computers are not designed to be frequently opened and closed, and internal power packs are not designed to be routinely disconnected and reconnected. Finally, whilst replacing the internal power supply, it is necessary to switch off the palmtop computer, which can disrupt running programs, may delay the reception of data, and, in some situations and applications, can be disruptive and may result in adverse, knock on effects.

The present invention is directed to providing a portable power supply solution for palmtop computers to enable their continuous operation for extended periods of time, particularly in situations where connection to a mains power supply is not feasible.

### SUMMARY OF THE INVENTION

It is an aim of the present invention to provide a power supply for a handheld data-processing and telecommunication device, such as a palmtop computer, that allows the device to be used for extended periods of time without requiring recharging by coupling to a mains power supply.

By handheld data-processing and telecommunication device, both keyboard-based palmtop computers such as the Psion Organizer™, and tablet computers such as 3Com's Palm Pilot™ are intended.

Accordingly, in a first aspect, the present invention is directed to providing a portable power supply for powering a handheld data-processing and telecommunication device such as a palmtop computer, consisting of an external, easily detached and exchangeable battery pack and an internal backup.

Preferably the portable power supply is retrofitted to the handheld data-processing and telecommunication device, and abutted thereto and held in rigid alignment therewith.

Preferably the battery pack comprises an energy source including voltaic cells selected from the list of single use voltaic cells and rechargeable voltaic cells.

Preferably, the internal backup up is a rechargeable voltaic cell, allowing the provision of energy whilst said detachable and exchangeable battery pack is detached and exchanged, facilitating the continuous operation of said data-processing and telecommunication device.

Preferably the portable power supply is characterized by meeting at least one of the following specifications:

(a) ability to work over temperature range −13 ° F. to 131° F.

(b) ability to be safely exposed to temperatures over temperature range −40° F. to 149° F.

(c) ability to function at altitudes of up to 15,000 Ft a above sea-level, and of being stored at altitudes of up to 40,000 Ft above sea-level.

(d) fulfilling tactical requirements of US Military Specification 810E

(e) fulfilling tactical requirements of US Military Specification 461 E

In a second aspect, the present invention is directed to providing a portable data-processing and telecommunication system comprising a handheld data-processing and telecommunication device, having an internal power supply, and an external power supply comprising an easily detached and exchangeable e battery pack.

Preferably, the portable data-processing and telecommunication system is characterized by meeting at least one of the following specifications:

(a) ability to work over temperature range −13° F. to 131° F.

(b) ability to be safely exposed to temperatures over temperature range −40° F. to 149° F.

(c) ability to function at altitudes of up to 15,000 Ft above sea-level, and of being stored at altitudes of up to 40,000 Ft above sea-level.

(d) fulfilling tactical requirements of US Military Specification 810E

(e) fulfilling tactical requirements of US Military Specification 461 E

### BRIEF DESCRIPTION OF THE FIGURES

The present invention will be further understood and appreciated from the following detailed description taken in conjunction with the drawings in which:

FIG. 1 is a schematic front view illustration of a palmtop computer of the prior art.

FIG. 2 is a schematic front view illustration of a palmtop computer in accordance with one embodiment of the present invention.

FIG. 3 is a schematic side view illustration of the palmtop computer of FIG. 2.

### DESCRIPTION OF THE PREFERRED EMBODIMENTS

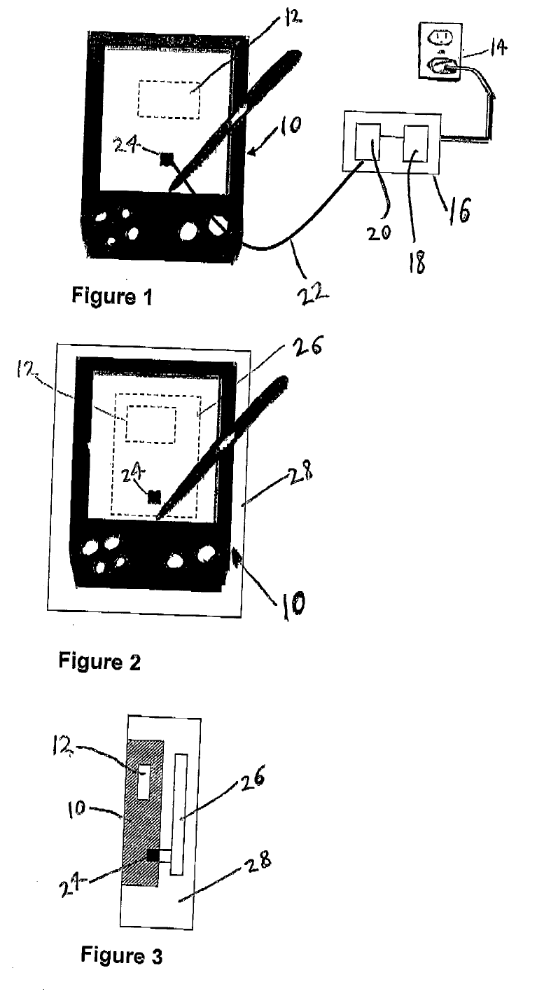

Referring now to FIG. 1, there is shown a handheld data-processing and telecommunication device of the prior art, illustrated herein as a palmtop computer 10 having an internal power supply 12, being a rechargeable battery, that may be recharged by connecting the palmtop computer 10 to a mains power source 14 via a power supply 16 that consists essentially of a step-down transformer 18 and a rectifier 20. The power supply 16 connects to the palmtop computer 10 via a cable 22 that terminates in some kind of jack plug which connects into a socket 24 on the palmtop computer 10, typically on the back or side thereof.

Referring now to FIGS. 2 and 3, there is shown schematically, one embodiment of the present invention, consisting of a portable power supply 26 that is retrofittable to the palmtop computer 10, is external thereto, and held in rigid alignment therewith. The portable power supply 26 is an external battery (dry electrochemical cell) which may be single use, but is preferably rechargeable. The portable power supply 26 may be quickly and easily connected and disconnected from the palmtop computer 10, typically connecting to the socket 24 mentioned hereinabove. The portable power supply 26 fits into a framework or casing 28 that fits onto or around the palmtop computer 10. The framework/casing 28 may simply be a shell for holding the portable power supply 26 in rigid alignment, external to the palmtop computer 10. The framework/casing 28 may serve other functions as well however, such as protecting and increasing the general ruggedness of the palmtop computer 10.

The external portable power supply 26 may be easily connected to the palmtop computer 10, or disconnected therefrom, to allow a spent external portable power supply 26 to be replaced with a fresh one. When the external portable power supply 26 is disconnected or spent, the palmtop computer 10 is powered by the internal power supply 12, allowing continuous operation. Preferably the internal power supply 12 of the palmtop computer 10 is kept fully charged by the external portable power supply 26, but, is anyway only expected to operate for brief periods, typically several minutes, between changes of external portable power supply 26, and thus only serves as a backup.

The portable data-processing and telecommunication system including a handheld data-processing and telecommunication device, such as a palmtop computer, having both an internal power supply and an external power supply consisting of an easily detachable and exchangeable battery pack described hereinabove, is very useful when living outdoors, perhaps on camping holidays, on safari and the like. Indeed, it is useful in a wide variety of applications where mains power is not available or inconvenient, and is expected to be of interest to the military, for use on the battlefield, and by undercover agents and the like. Accordingly, the portable power supply 26 will preferably meet military specifications. For example, it is preferable that the portable power supply 26 and the palmtop computer 12 will be adapted to operate over the temperature range of between −13° F. to 131° F., and to withstand temperatures of −40° F. up to 149° F. Similarly, the portable power supply 26 and the palmtop computer 12 should have the ability to function at altitudes of up to 15,000 Ft above sea-level, and of being stored at altitudes of up to 40,000 Ft above sea-level. Likewise, both devices should meet the tactical requirements of US Military Specification of 810E and 461E, for example.

No particular chemical cells are discussed or claimed herein, as the cells of the prior art all have well known capabilities, advantages and disadvantages, and the correct choice for a particular scenario is based on issues well known to the man of the art.

It will be appreciated that the invention is not limited to what has been described hereinabove merely by way of example. Rather, the invention is limited solely by the claims which follow, in which the word ‘comprise’, and variations thereof, such as comprising, comprises and the like, are to be understood inclusively, and in a non-limiting fashion, implying that the components or steps specified are included, but not necessarily to the exclusion of other components or steps.

What is claimed is:

1. A portable power supply for powering a handheld data-processing and telecommunication device, comprising a conventional battery situated internally to said device, and an external, easily detached and exchangeable battery pack, whereby the external, easily detached and exchangeable battery pack powers the device, and the internal, conventional battery acts as a backup power supply.

2. A portable power supply as claimed in claim 1, wherein said handheld data-processing and telecommunication device is a palmtop computer.

3. A portable power supply as claimed in claim 2 wherein, in use, said portable power supply is retrofitted to said palmtop computer, and abutted thereto and held in rigid alignment therewith.

4. A portable power supply as claimed in claim 1, wherein said battery pack comprises is an energy source including voltaic cells selected from the list of single use voltaic cells and rechargeable voltaic cells.

5. A portable power supply as claimed in claim 1, wherein said internal backup up is rechargeable voltaic cell allowing the provision of energy whilst said detachable and exchangeable battery pack is detached and exchanged, facilitating the continuous operation of said data-processing and telecommunication device.

6. A portable power supply as claimed in claim 5, wherein easily detached and exchangeable battery pack, in addition to powering the device, further functions as a recharging source for the internal backup, to keep internal backup fully charged.

7. A portable power supply as claimed in claim 1 is characterized by meeting at least one of the following specifications:
(i) ability to work over temperature range −13° F. to 131° F.
(ii) ability to be safely exposed to temperatures in the range −40° F. to 149° F.
(iii) ability to function at altitudes of up to 15,000 Ft above sea-level, and of being stored at altitudes of up to 40,000 Ft above sea-level.
(iv) fulfilling tactical requirements of US Military Specification 810E
(v) fulfilling tactical requirements of US Military Specification 461 E.

8. A portable data-processing and telecommunication system comprising a handheld data-processing and telecommunication device, having an internal power supply, and an external power supply comprising an easily detachable and exchangeable battery pack.

9. A portable data-processing and telecommunication system as claimed in claim 8 wherein said portable data-processing and telecommunication system is characterized by meeting at least one of the following specifications:
(a) ability to work over temperature range −13° F. to 131° F.
(b) ability to withstand exposure to temperatures in range from −40° F. to −149° F.
(c) ability to function at altitudes of up to 15,000 Ft above sea-level, and of being stored at altitudes of up to 40,000 Ft above sea-level.
(d) fulfilling tactical requirements of US Military Specification 810E
(e) fulfilling tactical requirements of US Military Specification 461 E.
